(19) United States
(12) Patent Application Publication
(10) Pub. No.: US 2005/0189429 A1
(43) Pub. Date: Sep. 1, 2005

(54) THERMOSTAT AND METHOD FOR ADAPTIVELY PROVIDING A CHANGEOVER BETWEEN HEAT AND COOL

(76) Inventor: Robert Louis Breeden, Port Charlotte, FL (US)

Correspondence Address: ROBERT LOUIS BREEDEN, 6964 DAVID BLVD, PORT CHARLOTTE, FL, 33981, US

(21) Appl. No.: 10/788,691

(22) Filed: Feb. 28, 2004

(51) Int. Cl. F23N 5/20; G05D 23/00

(52) U.S. Cl. 236/46 R

(57) ABSTRACT

A thermostat (800) operates continuously in a current mode (304) that is one of a heating mode and a cooling mode, and completes (520, 610) a demand for one of heating and cooling in accordance with the current mode. After completing the demand and until another demand occurs for one of heating and cooling, the thermostat repeatedly makes (302) measurements of a sensed room temperature, and determines (310, 414), from the measurements, whether the sensed room temperature has finished a post-demand overshoot. In response to determining that the sensed room temperature has finished the post-demand overshoot, the thermostat records (316, 418) an evaluation temperature, and decides whether to make an automatic changeover from the current mode to a new mode by periodically comparing (318, 420) the sensed room temperature with the evaluation temperature.

### FIELD OF THE INVENTION

This invention relates in general to temperature controllers for heating and cooling systems, and more specifically to a thermostat and method for adaptively providing a changeover between heat and cool.

### BACKGROUND OF THE INVENTION

Thermostats for use with a building heating and cooling system are well known. A typical prior-art thermostat provides a mode switch having at least two positions for allowing a user to changeover manually between a heating mode, in which the thermostat controls the heating system; and a cooling mode, in which the thermostat controls the cooling system. Such thermostats generally have used a single setpoint temperature. Unfortunately, these thermostats require frequent user attention to the mode switch during temperate seasons such as spring and fall, in which cooling may be desired during the day, and heating at night.

In an attempt to automate the changeover between heating and cooling, manufacturers of prior-art thermostats have constructed “automatic-changeover” thermostats, which have used first and second setpoint temperatures, respectively, for heating and cooling. In such prior-art thermostats, the first and second setpoint temperatures are not independent of each other, because, in effect, both are active simultaneously. The first setpoint temperature is required to be less than the second setpoint temperature by a predetermined number of degrees, e.g., 3 degrees F., to prevent excessive cycling of the thermostat between heating and cooling due to a demand for heating causing the sensed room temperature to move into the cooling operational range, and vice versa. Unfortunately, without manual intervention, this type of prior-art thermostat forces the average room temperature when using heat to be at least 3 degrees F. cooler than the average room temperature when using cooling, which some people find uncomfortable.

Thus, what is needed is an automatic changeover thermostat in which the first and second setpoint temperatures can be set independently of each other, without concern for excessive cycling between heating and cooling. Such a thermostat preferably will allow the use of a single setpoint temperature for both heating and cooling, if desired, without requiring manual user intervention to select between the heating and cooling modes.

### BRIEF DESCRIPTION OF THE DRAWINGS

FIG. 1 is a flow diagram depicting operation of a prior-art thermostat when in a heating mode.

FIG. 2 is a flow diagram depicting operation of a prior-art thermostat when in a cooling mode.

FIGS. 3 to 7 are flow diagrams depicting operation of a thermostat in accordance with the present invention.

FIG. 8 is an electrical block diagram of the thermostat in accordance with the present invention.

FIG. 9 is a graphical depiction of the performance measured on a working model of the thermostat in accordance with the present invention.

### DETAILED DESCRIPTION OF THE PREFERRED EMBODIMENT

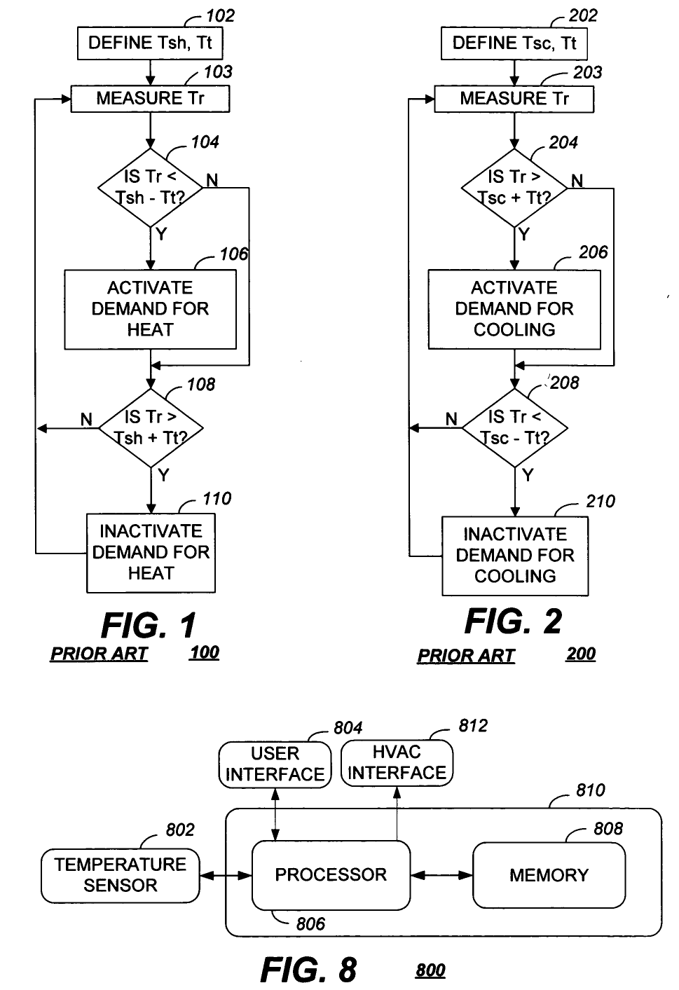

U.S. Pat. No. 6,681,848 issued Jan. 27, 2004 to Breeden is hereby incorporated herein by reference. Referring to FIG. 1 of the instant disclosure, a flow chart 100 depicts operation of a prior-art thermostat when in a heating mode. The flow begins with defining 102 a user-programmed setpoint temperature Tsh to be the target temperature when in the heating mode, and a temperature tolerance Tt (preferably pre-programmed by the manufacturer of the thermostat) within which the temperature is to be maintained, centered about the setpoint temperature Tsh. For example, if a user sets Tsh at 75, and Tt is pre-programmed at 0.5, the thermostat will attempt to maintain the sensed room temperature between 74.5 and 75.5 degrees F. Next, the room temperature Tr sensed by the thermostat is measured 103 and recorded. At step 104, a first comparison is made to determine whether Tr is less than Tsh minus Tt. If so, a demand for heat is activated 106, and the flow then moves to step 108. If not, step 106 is skipped, and the flow moves directly to step 108. At step 108, a second comparison is made to determine whether Tr is greater than Tsh plus Tt. If so, any existing demand for heat is inactivated 110, and the flow returns to step 103. If not, the flow returns directly to step 103.

Referring to FIG. 2, a flow chart 200 depicts operation of a prior-art thermostat when in a cooling mode. The flow begins with defining 202 a user-programmed setpoint temperature Tsc to be the target temperature when in the cooling mode, and a temperature tolerance Tt (preferably pre-programmed by the manufacturer of the thermostat) within which the temperature is to be maintained, centered about the setpoint temperature Tsc. For example, if a user sets Tsc at 76, and Tt is pre-programmed at 0.5, the thermostat will attempt to maintain the sensed room temperature between 75.5 and 76.5 degrees F. Next, the room temperature Tr sensed by the thermostat is measured 203 and recorded. At step 204, a first comparison is made to determine whether Tr is greater than Tsc plus Tt. If so, a demand for cooling is activated 206, and the flow then moves to step 208. If not, step 206 is skipped, and the flow moves directly to step 208. At step 208, a second comparison is made to determine whether Tr is less than Tsc minus Tt. If so, any existing demand for cooling is inactivated 210, and the flow returns to step 203. If not, the flow returns directly to step 203.

Activation and inactivation of a demand for heating or cooling by a thermostat in accordance with the present invention is similar to that depicted in the flow charts 100 and 200, respectively, when in the heating mode or in the cooling mode. What is different is the method employed by the thermostat in accordance with the present invention for deciding whether and when to switch into the heating mode or into the cooling mode.

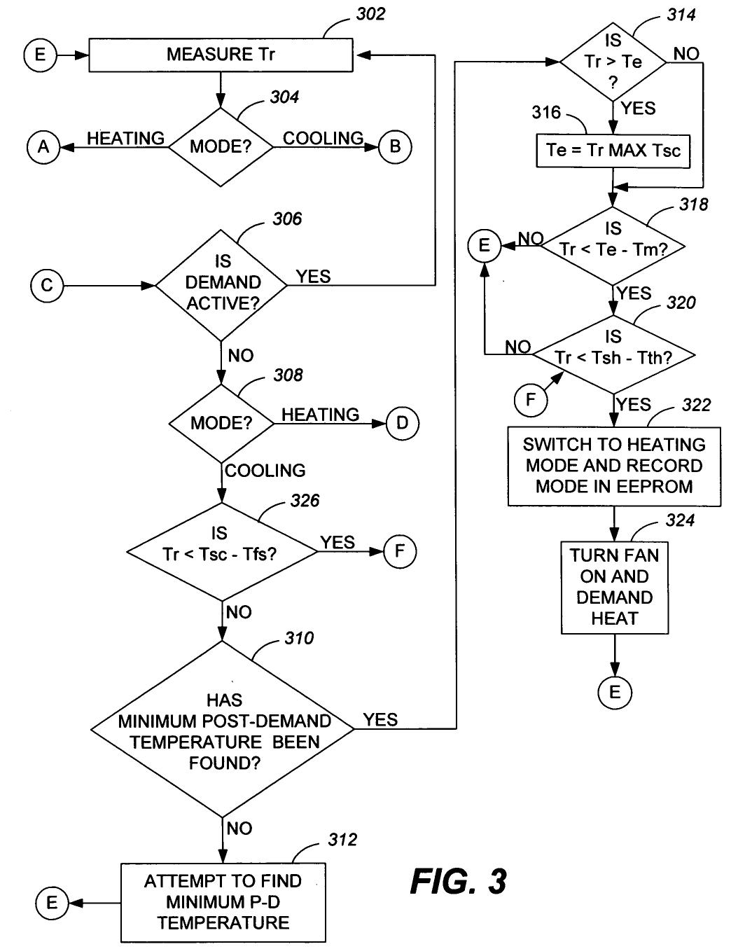

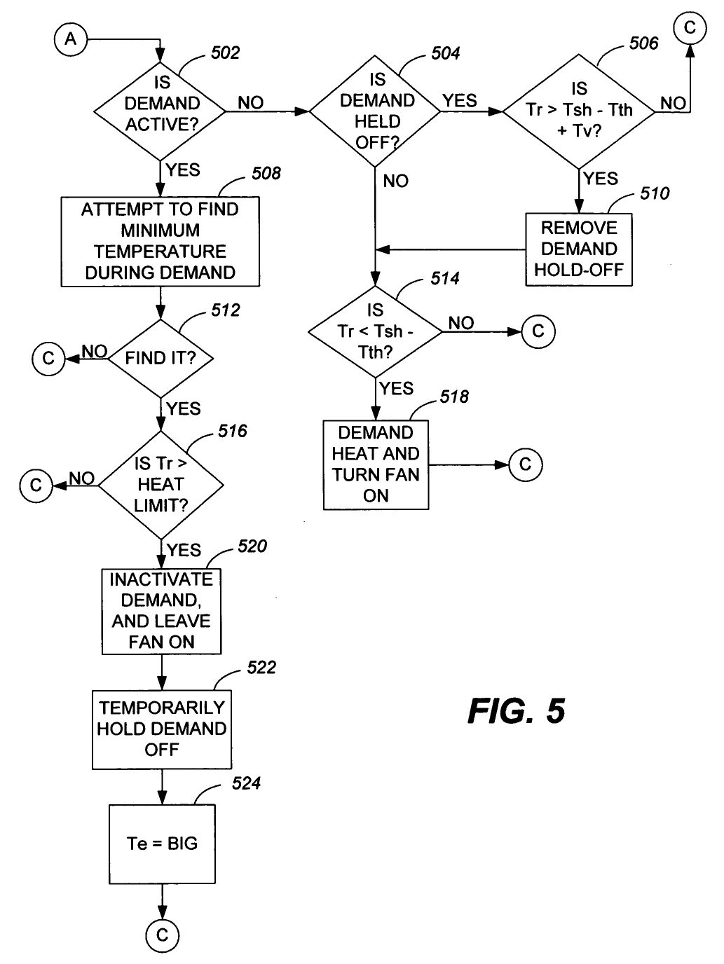

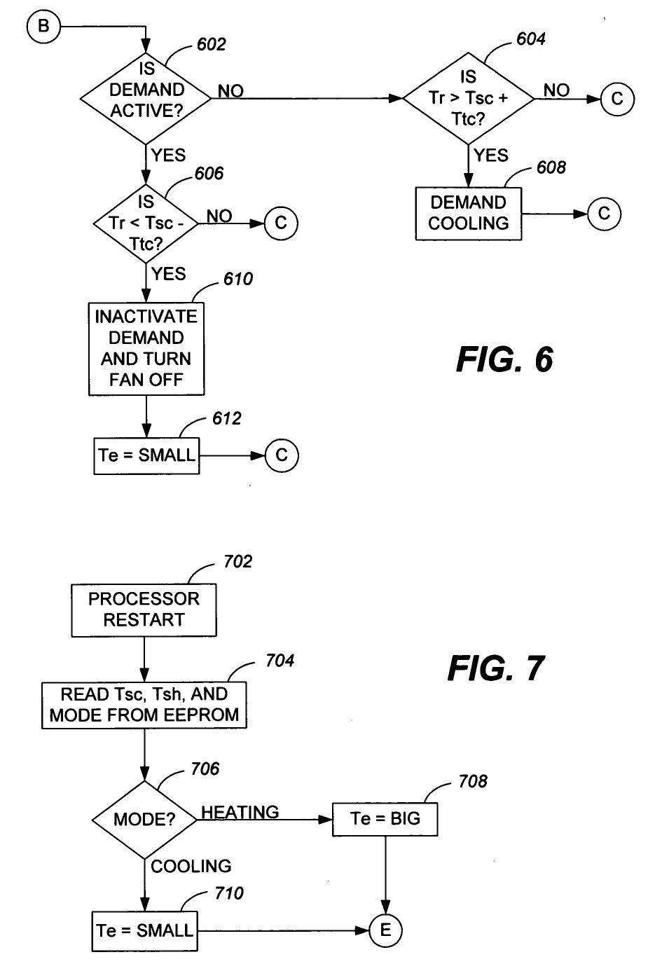

Referring to FIG. 3, a flow chart depicts operation of a thermostat in accordance with the present invention. The flow begins with measuring 302 the sensed room temperature Tr. Then at step 304 the mode of the thermostat is checked. The thermostat is arranged such that it operates continuously in one of the heating mode, in which the thermostat controls the heating system, and the cooling mode, in which the thermostat controls the cooling system. When the mode is heating, the flow moves to step 502 (FIG. 5) to determine whether a demand for heat is active. If so, the thermostat attempts 508, through well-known techniques, to find the minimum sensed room temperature reached during the demand. This is done because the sensed room temperature Tr is subject to substantial undershoot and overshoot in the heating mode. In the heating mode, undershoot is defined herein as a drop in the sensed room temperature when the demand for heat begins, due to cooler air being circulated around the thermostat by the heating, ventilation, and air conditioning (HVAC) system fan. Overshoot is defined herein as an increase in the sensed room temperature when the demand for heat is inactivated and the HVAC system fan stops. Overshoot is believed to be caused by poorly-mixed pockets of warm and cool air, which redistribute themselves after the fan stops, the warm air rising and the cool air falling. Whatever the causes, undershoot and overshoot are problems that need to be dealt with in an automatic changeover thermostat. Undershoot causes the heating system to operate for longer than is desirable, temporarily making the heated area warmer than desired at the completion of the demand. Overshoot, on the other hand, increases the difficulty of making an accurate decision as to whether the thermostat should switch from the heating mode to the cooling mode.

In the cooling mode, overshoot is defined herein as a further drop in the sensed room temperature after the demand for cooling is inactivated. Undershoot is defined herein in the cooling mode as a further rise in the sensed room temperature after a demand for cooling begins. In the particular installation in which an embodiment of the present invention was evaluated, neither overshoot nor undershoot was large enough in the cooling mode to require any special handling.

Again referring to FIG. 5, after step 508 the thermostat checks 512 whether it has found the minimum temperature during the demand. If not, the flow moves to step 306 (FIG. 3) to check whether the demand is still active. If so, the flow returns to step 302 to again measure the sensed room temperature Tr. If, on the other hand, at step 512 the minimum Tr has been found, then the thermostat checks 516 whether Tr is greater than a heat limit. To minimize the effect of the undershoot on the run time of the heating system, the heat limit is preferably less than the temperature at which the demand was started. Empirical observation has indicated that a reasonable value for the heat limit is 0.1 degree F. below the temperature at which the demand was started. If at step 516 the sensed room temperature is not greater than the heat limit, the flow again returns to step 306. If, on the other hand, the sensed room temperature is greater than the heat limit, the thermostat then inactivates 520 the demand, leaving the fan turned on. The fan preferably is allowed to remain in operation until a peak in Tr is detected, or until fifteen minutes have passed, whichever happens first. The reason for leaving the fan on is to better mix the air in the heated area, which will reduce the overshoot. In addition, the thermostat temporarily holds 522 the demand off. This is necessary at this point, because the sensed room temperature is below the temperature at which the demand was started, and we do not want the demand for heat to be reactivated. The thermostat also sets 524 the evaluation temperature Te to a big value, e.g., 600 degrees F., in preparation for some post-demand calculations to follow. The flow then returns to step 306.

If, on the other hand, at step 502 the demand is not active, the thermostat then checks 504 whether the demand is held off. If the demand is held off, the thermostat checks 506 whether the sensed room temperature Tr is greater than the heating setpoint temperature Tsh minus the temperature tolerance for heat Tth plus a temperature variation Tv. Tth is preferably a small value, e.g., 0.1 degree F., to further reduce the undershoot and overshoot. Tv is also preferably a small value, e.g., 0.05 degrees F., which provides sufficient margin for any temperature variations in the A/D converter of the temperature sensor. In essence, step 506 is simply checking whether the sensed room temperature is high enough to allow removing the hold-off of the demand without any risk of reactivating the demand. If so, the thermostat removes 510 the hold-off of the demand and the flow moves to step 514. If, on the other hand, at step 506 the temperature is not high enough, the flow returns to step 306. If, on the other hand, at step 504 the demand is not held off, the flow moves to step 514 to check whether the sensed room temperature is less than the heat setpoint temperature Tsh minus the temperature tolerance for heat Tth. If so, the thermostat activates 518 a demand for heat and turns the fan on, and the flow returns to step 306. If not, the flow simply returns to step 306.

When at step 304 (FIG. 3) the mode is cooling, the flow moves to step 602 to check whether a demand for cooling is active. If not, the thermostat checks 604 whether the sensed room temperature Tr is greater than the cooling setpoint temperature Tsc plus the temperature tolerance for cooling Ttc, e.g., 0.5 degrees F. If so, the thermostat activates 608 a demand for cooling, and the flow then returns to step 306. If not, the flow simply returns to step 306. If, on the other hand, at step 602 the demand is active, then the thermostat checks 606 whether Tr is less than Tsc minus Ttc. If so, the thermostat inactivates 610 the demand and turns the fan off. In addition, the evaluation temperature is set 612 to a small value, e.g., 10 degrees F. The flow then returns to step 306. If, on the other hand, step 606 produces a negative result, the flow returns immediately to step 306.

If at step 306 the demand is not active, then at step 308 the mode is checked. If the mode is cooling then the thermostat checks whether the sensed room temperature Tr is less than the cooling setpoint temperature Tsc minus a force-switchover temperature Tfs, e.g., 1.25 degrees F. If not, the thermostat then checks 310 whether the minimum post-demand temperature been found. This would signify that the bottom of any overshoot past the lower cooling limit has been reached, and Tr is now rising. If not, the thermostat continues to attempt 312 to find the minimum post-demand temperature, through well-known techniques, and the flow returns to step 302.

If, on the other hand, step 310 produces an affirmative result, the thermostat checks 314 whether Tr is greater than Te. If so, at step 316 Te is set equal to Tr up to a maximum limit preferably defined by the setpoint temperature for cooling Tsc. It will be appreciated that, alternatively, a maximum limit higher or lower than Tsc can be substituted for Tsc, if desired. If at step 314 Tr is not greater than Te, then step 316 is skipped. In either case, flow then moves to step 318, to check whether Tr is less than Te minus Tm, the temperature margin for mode switching. If so, the thermostat checks 320 whether Tr is also less than Tsh-Tth. In other words, the thermostat is checking whether Tr is low enough to cause a demand for heat in the heating mode. If so, the thermostat switches 322 to the heating mode and records the new mode in EEPROM. In addition, the thermostat turns the fan on 324 and demands heat. The flow then returns to step 302. If either step 318 or step 320 produces a negative result, the flow returns immediately to step 302. If, on the other hand, at step 326 Tr is less than Tsc minus Tfs, the flow skips immediately to step 320. This advantageously allows a user to force a mode change from the cooling mode to the heating mode by increasing the heating and cooling setpoints by about two degrees F. above their current settings.

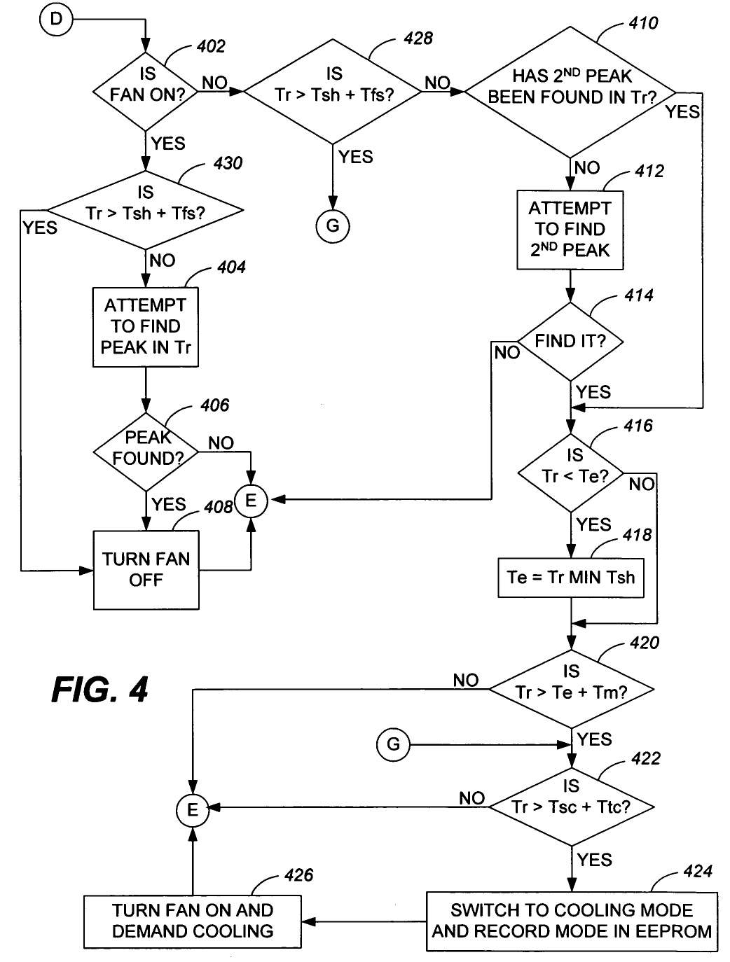

If, on the other hand, at step 308 the mode is heating, then the flow moves to step 402 (FIG. 4) to check whether the fan is on. If so, the thermostat checks 430 whether the sensed room temperature Tr is greater than the setpoint temperature for heating Tsh plus the force-switchover temperature Tfs. If not, the thermostat attempts 404 to find a peak in Tr (due to overshoot after the demand ends), through well-known techniques. The thermostat then checks 406 whether the peak has been found. If so, the thermostat turns the fan off 408, and the flow returns to step 302 for another temperature measurement. If at step 406 the peak has not been found, the flow returns immediately to step 302. If, on the other hand, at step 430 an affirmative result is produced, the flow goes immediately to step 408 to turn the fan off. It will be appreciated that, as a backup, a timer can be used to turn off the fan if it operates for too long, e.g., more than fifteen minutes, after the demand for heat has ended.

If, on the other hand, at step 402 the fan is not on, then the thermostat checks 428 whether the sensed room temperature Tr is greater than the setpoint temperature for heating Tsh plus the force-switchover temperature Tfs. If not, the thermostat checks 410 whether a second peak (due to stopping the fan) has been found in Tr. If not, the thermostat attempts 412 to find the second peak through well-known techniques. If at step 414 the thermostat has found the peak, that fact is recorded, so that the thermostat will not continue testing for the peak, and the flow moves to step 416. If not, the flow returns to step 302 for another temperature measurement. If, on the other hand, at step 410 the thermostat determines that the second peak has already been found, then the flow skips immediately to step 416.

At step 416 the thermostat checks whether Tr is less than the evaluation temperature Te. If so, Te is set 418 equal to Tr down to a minimum value preferably equal to the setpoint temperature for heat Tsh, and the flow moves to step 420. It will appreciated that, alternatively, another minimum value different from Tsh can be used instead, if desired. If at step 416 Tr is not less than Te, then the flow skips immediately to step 420, where the thermostat checks whether Tr is greater than Te plus Tm, the temperature margin for switching modes. If so, the thermostat checks 422 whether Tr is also greater than Tsc, the setpoint temperature for cooling, plus Ttc, the temperature tolerance for cooling. A negative result in either step 420 or step 422 results in the flow returning to step 302. A positive result in both will result in the thermostat switching 424 to the cooling mode and recording the new mode in EEPROM. In addition, the thermostat will turn the fan on 426 and demand cooling, after which the flow will return to step 302.

If at step 428 a positive result is produced, the flow skips immediately to step 422. This advantageously allows a user to force the thermostat to switch from the heating mode to the cooling mode by lowering both the heating and cooling setpoint temperatures by about two degrees F. below their current settings. Perhaps more importantly, step 428 acts as a “safety net” for forcing a switch to the cooling mode when no peak is found in step 412 and Tr has moved higher than expected, e.g., 1.25 degrees F. above the setpoint temperature. This anomaly can occur when normal daytime heating follows closely after a demand for heat. Under such conditions the overshoot following the demand can blend seamlessly with an upward trend in Tr produced by the normal daytime heating, leaving no detectable peak in the Tr sequence.

As described herein above, the combination of an early inactivation of the demand for heat and judicious operation of the fan thereafter advantageously reduces the amount of overshoot occurring after the demand for heat. In one embodiment before these techniques were incorporated, the observed overshoot was about two degrees F. beyond the setpoint temperature for heat. After incorporating these techniques, the observed overshoot has been reduced to a much more desirable limit of about 0.8 degree F. above the setpoint temperature for heat.

It is important to note that, while the foregoing disclosure has described separate heating and cooling setpoint temperatures, it is possible to utilize the same identical temperature value for both setpoints. In other words, the thermostat in accordance with the present invention can be manufactured as a single-setpoint thermostat, advantageously making the thermostat easier for the user to understand and operate. All the user has to do is set the desired temperature, and the thermostat will demand heating or cooling, as needed, to maintain the desired temperature.

Referring to FIG. 7, a flow diagram depicts a startup operation of the thermostat in accordance with the present invention. The flow begins with a processor restart 702, which can happen, for example, after power is removed from the thermostat and then restored. After the processor restart, the processor reads 704 the cooling and heating setpoint temperatures and the mode (heating or cooling) from EEPROM. The processor then checks 706 whether the mode is heating or cooling. If the mode is heating, the processor initializes 708 Te to a big value, e.g., 600 degrees F. If the mode is cooling, the processor initializes 710 Te to a small value, e.g., 10 degrees F. The flow then moves to step 302 (FIG. 3) to measure the temperature.

Referring to FIG. 8, an electrical block diagram 800 of the thermostat in accordance with the present invention comprises a temperature sensor 802, e.g., the SHT11 sensor manufactured by Sensirion AG of Zurich, Switzerland, for sensing a room temperature, and a user interface 804, e.g., a conventional liquid crystal display and pushbuttons for interfacing with a user. It will be appreciated that, alternatively, other similar types of sensors and displays can be utilized as well. The temperature sensor 802 and the user interface 804 are coupled to a conventional processor 806, e.g., the BS2p processor available from Parallax, Inc. of Rocklin, Calif., for controlling the thermostat in accordance with the present invention. It will be appreciated that, alternatively, other similar processors can be utilized for the processor 806. In addition, the processor 806 is coupled to a heating, ventilation, and air conditioning (HVAC) interface 812 for controlling the HVAC system. The HVAC interface preferably includes three conventional relays (not shown) for independently controlling the heating, cooling, and fan portions of the HVAC system. The processor 806 is also coupled to a conventional memory 808, e.g., RAM, ROM, EEPROM, for programming the processor 806 in accordance with the present invention, and for storing operating variables and constants. It will be appreciated that the processor 806 and the memory 808 can be manufactured in combination as a module 810 for use in a thermostat in accordance with the present invention. It will be appreciated that additional conventional elements (not shown), such as a battery or an external power source can be utilized to provide operating power for the thermostat.

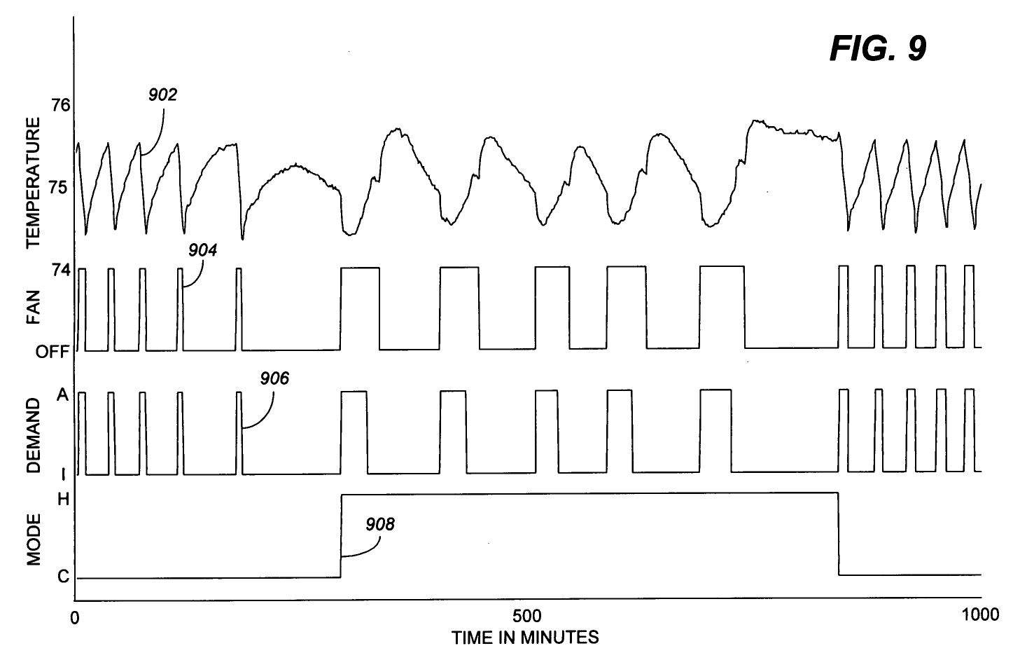

Referring to FIG. 9, a graphical depiction of the performance measured on a working model of the thermostat in accordance with the present invention includes a plot 902 of the sensed room temperature versus time. Three additional plots 904, 906, and 908 are included depicting, respectively, the state of the fan (on or off), the demand (active or inactive), and the mode (heating or cooling). For the duration of this test, both the heating and cooling setpoint temperatures were kept at 75.0 degrees F. The window of time depicted is a period of just under seventeen hours, during which the thermostat began in the cooling mode, switched to the heating mode overnight, and then returned to the cooling mode during the next day. Throughout the period, the thermostat smoothly maintained the sensed room temperature between 74.3 and 75.8 degrees F. Note that even with the heating and cooling setpoint temperatures set to identical values, there advantageously is no oscillation between heating and cooling. Note also that, in the heating mode, operation of the fan is extended past the end of the demand, advantageously reducing the overshoot.

It should be clear from the preceding disclosure that the present invention provides an automatic changeover thermostat in which the first and second setpoint temperatures advantageously can be set independently of each other, without concern for excessive cycling between heating and cooling. Such a thermostat beneficially allows the use of a single setpoint temperature for both heating and cooling, if desired, without requiring manual user intervention to select between the heating and cooling modes.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A thermostat for providing an automatic changeover from a current mode to a new mode, the current mode and the new mode being alternate ones of a heating mode, in which the thermostat controls a heating system, and a cooling mode, in which the thermostat controls a cooling system, the thermostat comprising:
a sensor for measuring a sensed room temperature;
a processor coupled to the sensor for controlling the thermostat;
a memory coupled to the processor for storing variables and software for programming the processor; and
a heating, ventilation, and air conditioning (HVAC) interface coupled to the processor for controlling the heating and cooling systems, wherein the processor is programmed to:
operate the thermostat continuously in one of the heating mode and the cooling mode;
complete a demand for one of heating and cooling in accordance with the current mode; and
after completing the demand, and until another demand occurs for one of heating and cooling:
repeatedly make measurements of a sensed room temperature;
determine, from the measurements, whether the sensed room temperature has finished a post-demand overshoot;
record an evaluation temperature, in response to determining that the sensed room temperature has finished the post-demand overshoot; and
decide whether to make the automatic changeover by periodically comparing the sensed room temperature with the evaluation temperature.

2. The thermostat of claim 1, wherein the processor is further programmed, after recording the evaluation temperature, to
adjust the evaluation temperature in accordance with future measurements of the sensed room temperature.

3. The thermostat of claim 1, wherein the processor is further programmed to:
detect whether the automatic changeover to the new mode, when made, will cause an immediate demand for one of heating and cooling in the new mode; and
delay the automatic changeover until the automatic changeover will cause the immediate demand in the new mode.

4. The thermostat of claim 1, wherein, when in the heating mode, the processor is further programmed to
make a downward adjustment to the evaluation temperature in response to determining that the sensed room temperature has fallen below the evaluation temperature.

5. The thermostat of claim 1, wherein, when in the heating mode, the processor is further programmed to
switch to the cooling mode in response to the sensed room temperature becoming greater than the evaluation temperature by a predetermined margin.

6. The thermostat of claim 1, wherein, when in the cooling mode, the processor is further programmed to
make an upward adjustment to the evaluation temperature in response to determining that the sensed room temperature has risen above the evaluation temperature.

7. The thermostat of claim 1, wherein, when in the cooling mode, the processor is further programmed to
switch to the heating mode in response to the sensed room temperature becoming less than the evaluation temperature by a predetermined margin.

8. The thermostat of claim 1,
wherein the HVAC interface includes a fan controller for controlling an air mover of the heating and cooling systems, and
wherein, when in the heating mode, the thermostat is subject to a substantial post-demand temperature overshoot when the air mover operated during the demand is stopped after completing the demand, and
wherein, prior to determining, from the measurements, whether the sensed room temperature has finished the post-demand overshoot, the processor is further programmed to
reduce the temperature overshoot by extending the operation of the air mover after completing the demand, for a duration determined by at least one of (a) a predetermined time period, and (b) a detection of a peak in the sensed room temperature after completing the demand and while the air mover is in extended operation.

9. The thermostat of claim 1,
wherein, when in the heating mode, the thermostat is subject to a substantial undershoot in temperature early in the demand, and
wherein the processor is further programmed, after the demand has begun, to
detect, from the measurements, whether the sensed room temperature has reached a minimum during the undershoot; and
after detecting that the sensed room temperature has reached the minimum, stop the demand when the sensed room temperature returns to a stop-early temperature that is less than the temperature at which the demand was initiated.

10. The thermostat of claim 1, further comprising
a user interface coupled to the processor for interfacing with a user, wherein the processor is further programmed to:
cooperate with the user interface to allow the user to define and store in the memory a single setpoint temperature; and
utilize the single setpoint temperature as a target temperature for both the heating mode and the cooling mode.

11. A method in a thermostat for providing an automatic changeover from a current mode to a new mode, the current mode and the new mode being alternate ones of a heating mode, in which the thermostat controls a heating system, and a cooling mode, in which the thermostat controls a cooling system, the method comprising:
operating continuously in one of the heating mode and the cooling mode;
completing a demand for one of heating and cooling in accordance with the current mode; and
after completing the demand, and until another demand occurs for one of heating and cooling:
repeatedly making measurements of a sensed room temperature;
determining, from the measurements, whether the sensed room temperature has finished a post-demand overshoot;
recording an evaluation temperature, in response to determining that the sensed room temperature has finished the post-demand overshoot; and
deciding whether to make the automatic changeover by periodically comparing the sensed room temperature with the evaluation temperature.

12. The method of claim 11, further comprising, after recording the evaluation temperature,
adjusting the evaluation temperature in accordance with future measurements of the sensed room temperature.

13. The method of claim 11, further comprising:
detecting whether the automatic changeover to the new mode, when made, will cause an immediate demand for one of heating and cooling in the new mode; and
delaying the automatic changeover until the automatic changeover will cause the immediate demand in the new mode.

14. The method of claim 11, further comprising, when in the heating mode,
making a downward adjustment to the evaluation temperature in response to determining that the sensed room temperature has fallen below the evaluation temperature.

15. The method of claim 11, wherein, when in the heating mode, deciding whether to make the automatic changeover comprises
switching to the cooling mode in response to the sensed room temperature becoming greater than the evaluation temperature by a predetermined margin.

16. The method of claim 11, further comprising, when in the cooling mode,
making an upward adjustment to the evaluation temperature in response to determining that the sensed room temperature has risen above the evaluation temperature.

17. The method of claim 11, wherein, when in the cooling mode, deciding whether to make the automatic changeover comprises
switching to the heating mode in response to the sensed room temperature becoming less than the evaluation temperature by a predetermined margin.

18. The method of claim 11,
wherein, when in the heating mode, the thermostat is subject to a substantial post-demand temperature overshoot, when an air mover operated during the demand is stopped after completing the demand, and
wherein, prior to the step of determining, from the measurements, whether the sensed room temperature has finished the post-demand overshoot, the method further comprises
reducing the temperature overshoot by extending the operation of the air mover after completing the demand, for a duration determined by at least one of (a) a predetermined time period, and (b) a detection of a peak in the sensed room temperature after completing the demand and while the air mover is in extended operation.

19. The method of claim 11, wherein, when in the heating mode, the thermostat is subject to a substantial undershoot in temperature early in the demand, and
wherein the method further comprises after the demand has begun:
detecting, from the measurements, whether the sensed room temperature has reached a minimum during the undershoot; and
after detecting that the sensed room temperature has reached the minimum, stopping the demand when the sensed room temperature returns to a stop-early temperature that is less than the temperature at which the demand was initiated.

20. The method of claim 11, further comprising the steps of:
defining a single setpoint temperature; and
utilizing the single setpoint temperature as a target temperature for both the heating mode and the cooling mode.
